(19) United States
(12) Patent Application Publication
(10) Pub. No.: US 2012/0150544 A1
(43) Pub. Date: Jun. 14, 2012

(54) METHOD AND SYSTEM FOR RECONSTRUCTING SPEECH FROM AN INPUT SIGNAL COMPRISING WHISPERS

(76) Inventors: Ian Vince McLoughlin, SIngapore (SG); Hamid Reza Sharifzadeh, Singapore (SG); Farzaneh Ahmadi, Singapore (SG)

(21) Appl. No.: 13/392,385

(22) PCT Filed: Aug. 25, 2010
(86) PCT No.: PCT/SG10/00313

§ 371 Date: Feb. 24, 2012

Related U.S. Application Data
(60) Provisional application No. 61/236,680, filed on Aug. 25, 2009.

(51) Int. Cl. G10L 13/00

(52) U.S. Cl. 704/262; 704/258; 704/E13.001

(57) ABSTRACT

A system for reconstructing speech from an input signal comprising whispers is disclosed. The system comprises an analysis unit configured to analyse the input signal to form a representation of the input signal; an enhancement unit configured to modify the representation of the input signal to adjust a spectrum of the input signal, wherein the adjusting of the spectrum of the input signal comprises modifying a bandwidth of at least one formant in the spectrum to achieve a predetermined spectral energy distribution and amplitude for the at least one formant; and a synthesis unit configured to reconstruct speech from the modified representation of the input signal.

### TECHNICAL FIELD

This invention relates to a method and system for reconstructing speech from an input signal comprising whispers. The input signal may comprise entirely of whispers or may be a normally phonated speech with occasional whispers, or may comprise whisper-like sounds produced by people with speech impediments.

### BACKGROUND

The speech production process starts with lung exhalation passing through a taut glottis to create a varying pitch signal which resonates through the vocal tract, nasal cavity and out through the mouth. Within the vocal, oral and nasal cavities, the vellum, tongue, and lip positions play crucial roles in shaping speech sounds; these are referred to collectively as vocal tract modulators.

Whispered speech (i.e. whispers) can be used as a form of quiet and private communication through, for example, mobile phones. As a paralinguistic phenomenon, whispers can be used in different contexts. One may wish to communicate clearly, but is in a situation where the loudness of normal speech is prohibited, such as in a library where one would prefer to whisper to avoid disturbing others, or to avoid incurring the wrath of the librarian. Furthermore, whispering is also an essential communicative means for some people experiencing voice box difficulties. Unfortunately, whispering usually leads to reduced perceptibility and degree of understanding. The main difference between normally phonated speech and whispers is the absence of vocal cord vibrations in whispers. This may be caused by the normal physiological blocking of vocal cord vibrations when whispering or, in pathological cases, by the blocking of vocal cords due to a disease of the vocal system or by the removal of vocal cords due to a disease or a disease treatment.

When using a mobile phone in public places, there occasionally arises a need for private communication which may be achieved by whispering during the mobile phone use. At present, the recipient of the whispered speech would be disadvantaged due to the low quality and low intelligibility of the reconstructed speech signal. Thus, there arises a need to recreate a more normal-sounding speech using the whispered input so that the contents of the whispered speech may be made clearer to the recipient of the speech in the conversation. Such reconstruction, should preferably be performed prior to the signal transmission, since the bulk of speech communications systems are designed for fully phonated speech, and are thus likely to perform better if given the expected complete speech signal prior to the signal transmission.

Whispering is also a common mode of communication for people with voice box difficulties. Total laryngectomy patients, in many cases, have lost their glottis and their control to pass lung exhalation through the vocal tract. Partial laryngectomy patients, by contrast, may still retain the power of controlled lung exhalation through the vocal tract, but will usually have no functioning glottis left. Despite the loss of the glottis including vocal folds, both classes of patients may retain the power of upper vocal tract modulation, in other words, they may retain most of their speech production apparatus. Therefore, by controlling lung exhalation, they may still have the ability to whisper

Thus, reconstruction of natural sounding speech from whispers is useful in several applications in different scientific fields ranging from communications to biomedical engineering. However, despite the progress and great achievements in speech processing research, the study of whispered speech and its applications are practically absent in the speech processing literature. Thus, several important aspects of the reconstruction of natural sounding speech from whispers, in spite of the useful applications, have not yet been resolved by researchers. Furthermore, this type of speech regeneration has received relatively little research effort apart from a notable example synthesizing normal speech from whispers within a MELP codec by Morris. Although Morris' proposed approach performs a fine spectral enhancement, its mechanism of reconstruction and pitch insertion underlying the system are not suited for real time applications, for example, in the scenarios described above. This is because for pitch prediction, Morris' method implements an aligning technique which compares normal speech samples against whispered samples and then trains a jump Markov linear system (JMLS) for estimating pitch and voicing parameters accordingly. However, in both the above scenarios where whispering may occur, i.e. whispering by laryngectomy patients and in private mobile phone communications, the corresponding normal speech samples may not be available for comparison and regeneration purposes.

### SUMMARY

According to an exemplary aspect, there is provided a system for reconstructing speech from an input signal comprising whispers, the system comprising: an analysis unit configured to analyse the input signal to form a representation of the input signal; an enhancement unit configured to modify the representation of the input signal to adjust a spectrum of the input signal, wherein the adjusting of the spectrum of the input signal comprises modifying a bandwidth of at least one formant in the spectrum to achieve a predetermined spectral energy distribution and amplitude for the at least one formant; and a synthesis unit configured to reconstruct speech from the modified representation of the input signal.

According to another exemplary aspect, there is provided a method for reconstructing speech from an input signal comprising whispers, the method comprising: analysing the input signal to form a representation of the input signal; modifying the representation of the input signal to adjust a spectrum of the input signal, wherein the adjusting of the spectrum of the input signal comprises modifying a bandwidth of at least one formant in the spectrum to achieve a predetermined spectral energy distribution and amplitude for the at least one formant; and reconstructing speech from the modified representation of the input signal.

Note that the above-mentioned input signal may comprise only a portion of a speech signal from a speaker in a conversation. A final reconstructed speech to be sent to the receiver of the conversation may be formed by combining the reconstructed speech from the system and method provided in the above exemplary aspects and the remaining portion of the speech signal (which may be unprocessed or processed in a different manner).

In addition, the reconstructed speech from the system and method provided in the above exemplary aspects may be (i) replayed as-is to the receiver of the conversation or (ii) mixed with a proportion of the whispers before it is sent to the receiver of the conversation. Case (I) is more commonly performed.

Modifying a bandwidth of at least one formant in the spectrum to achieve a predetermined spectral energy distribution and amplitude for the at least one formant is advantageous. This increases the energies of certain whispered speech components and in doing so, differences in spectral energy between the reconstructed speech (especially components corresponding to the whispered speech) and normally phonated speech may be reduced, the intelligibility of the reconstructed speech may be improved, and the reconstructed speech can sound more like natural speech.

Preferably, the bandwidth of the at least one formant is modified while retaining a frequency of the at least one formant. By “retaining”, it is meant that the frequency of the at least one formant is kept relatively constant when modifying its bandwidth. This helps to keep the formant trajectories smooth while increasing the energies of the whispered speech components. Again, this can improve the intelligibility of the reconstructed speech and significantly increase the naturalness of the reconstructed speech.

Preferably, the predetermined spectral energy amplitude is derived based on an estimated difference between a spectral energy of whispered speech and a spectral energy of normally phonated speech. This helps to more accurately compensate for the differences in spectral energy between whispered speech and normally phonated speech.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 illustrates a system for reconstructing speech from an input signal comprising whispers according to an embodiment of the present invention;

FIG. 2 illustrates a spectrum of a vowel /a/ spoken with a normally phonated voice and a spectrum of the vowel /a/ spoken with a whisper;

FIGS. 3(a) and 3(b) respectively show an example output from a Whisper Activity Detector of the system of FIG. 1 and an example output from a Whispered Phoneme Classification unit of the system of FIG. 1;

FIG. 4 illustrates a block diagram of a spectral enhancement unit of the system of FIG. 1;

FIG. 5 shows the relation between the Probability Mass Function of formants extracted in the spectral enhancement unit of FIG. 4 and formant trajectories of these extracted formants with the input being a whispered speech frame of an input whispered vowel (/a/);

FIGS. 6(a) and 6(b) respectively illustrate formant trajectories for a whispered vowel (/i/) and for a whispered diphthong (/ie/) before and after processing in the spectral enhancement unit of FIG. 4;

FIGS. 7(a) and 7(b) respectively illustrate an original whisper formant trajectory before spectral adjustment in the spectral enhancement unit of FIG. 4 and a smoothed formant trajectory after the spectral adjustment;

FIGS. 8(a) and 8(b) respectively illustrate spectrograms of a whispered sentence before and after the reconstruction performed by the system of FIG. 1.

### DETAILED DESCRIPTION OF THE EXEMPLARY EMBODIMENTS

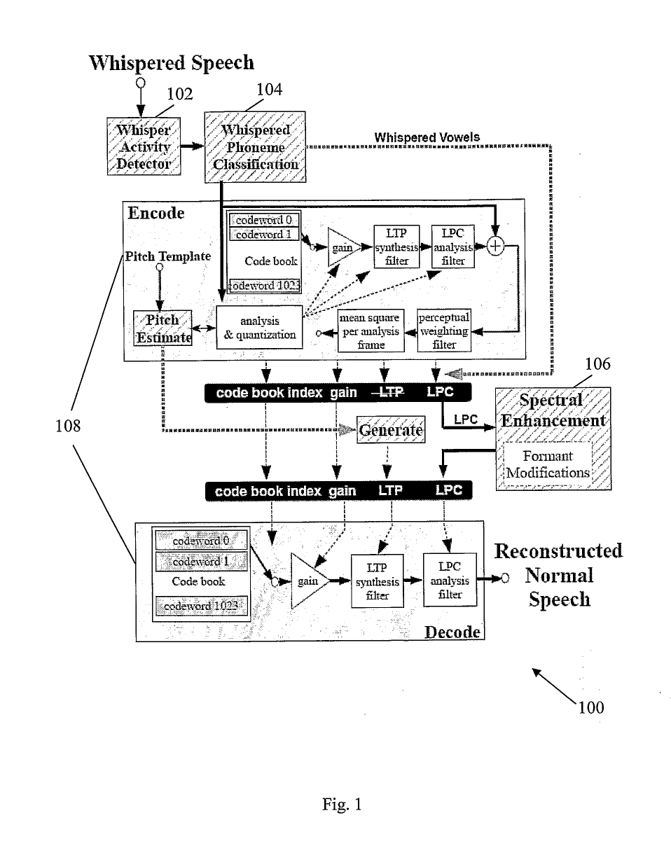

FIG. 1 illustrates a system 100 for reconstructing speech from an input signal comprising whispers according to an embodiment of the present invention.

As shown in FIG. 1, the system 100 comprises a plurality of pre-processing modules which in turn comprises a first pre-processing unit in the form of a Whisper Activity

Detector (WAD) 102 and a second pre-processing unit in the form of a Whispered Phoneme Classification unit 104. The system 100 further comprises an enhancement unit in the form of a spectral enhancement unit 106, and an analysis-synthesis unit 108 comprising an analysis unit and a synthesis unit. In system 100, the analysis unit is configured to analyse the input signal to form a representation of the input signal, the spectral enhancement unit 106 is configured to modify the representation of the input signal to adjust a spectrum of the input signal and the synthesis unit is configured to reconstruct speech from the modified representation of the input signal.

Note that the Long Term Prediction (LTP) output typically produced and used in a standard CELP unit is not used in system 100 (as shown by the striking out of the LTP output from the analysis unit). Instead, the LTP input to the synthesis unit is regenerated using the “Pitch Estimate” unit in the analysis unit. Furthermore, instead of using the Line Spectral Pairs (LSPs) typically produced and used in a standard CELP unit, in system 100, the Linear Prediction Coefficients (LPCs) (from which LSPs are normally formed) are adjusted. This is shown by the replacement of LSP with LPC at the output of the analysis unit.

The system 100 takes into consideration some whispered speech characteristics which will be elaborated below. The different parts of the system 100 will also be described in more detail below.

Whispered Speech Characteristics

This section outlines the relationship between whispered speech features and the production model of whispered speech. It further outlines the acoustic and spectral features of whispered speech.

The mechanism of whisper production is different from that of voiced speech. Hence, whispers have their own attributes which are preferably taken into consideration when implementing the pre-processing phase prior to the analysis-by-synthesis of the analysis-synthesis unit 108.

There is no unique definition of the term “whispered speech”: “whispered speech” can be broadly categorized into either soft whispers or stage whispers, each differing slightly from the other. Soft whispers (quiet whispers) are produced by normally speaking people to deliberately reduce perceptibility, for example, by whispering into someone's ear, and are usually used in a relaxed, low effort manner. These are produced without vocal fold vibration, are more commonly used in daily life and resemble the type of whispers produced by laryngectomy patients. Stage whispers, on the other hand, are whispers a speaker would use when the listener is some distance away from him or her. To produce stage whispers, the speech is deliberately made to sound whispery. Some partial phonation, requiring vocal fold vibration is involved in stage whispers. Although the system 100 is designed with soft whispers in mind, the whispers in the input signal of system 100 may also be in the form of stage whispers.

Characteristics of whispered speech may be considered in terms of: a) acoustical features arising from the way whispered speech is produced (excitation, source-filter model, etc) and b) spectral features in comparison with normal speech.

a) Acoustical Features of Whispered Speech

A physical feature of whispering is the absence of vocal cord vibration. Hence, the fundamental frequency and harmonics in normal speech are usually missing in whispered speech. Using a source filter model, exhalation can be identified as the source of excitation in whispered speech, with the shape of the pharynx adjusted to prevent vocal cord vibration.

When the glottis is abducted or partially abducted, there is a rapid flow of air through the glottal constriction. This flow forms a jet which impinges on the walls of the vocal tract above the glottis. An open glottis in the speech production process is known to act as a distributed excitation source in which turbulence noise is the primary excitation of the whispered speech system. Turbulent aperiodic airflow is thus the source of whispers, giving rise to a rich ‘hushing’ sound.

There are different descriptions of what happens at the glottal level when whispering. Catford, and Kallail and Emanuel described the vocal folds as narrowing, slit-like or slightly more adducted when whispering. Tartter stated that “whispered speech is produced with a more open glottis as compared to normal voices.” Weitzman by contrast defined whispered vowels as “produced with a narrowing (or even closing) of the membranous glottis while the cartilaginous glottis is open.”

Solomon et al. studied laryngeal configuration during whispering in 10 subjects using videotapes of the larynx. Three observations of the vocal fold vibrations were made: i) the vocal folds took the shape of an inverted V or narrow slit, ii) the vocal folds took the shape of an inverted Y, iii) the bowing of the anterior glottis was observed. It was concluded in Solomon that during the generation of soft whispers, the vocal folds have the dominant pattern of a medium inverted V.

Morris stated that the source-filter model must be extended beyond the glottis to include both the glottis and the lungs in order to describe whispered speech. Furthermore, Morris stated that the source of whispered speech is most likely not a single velocity source. Instead, it is more appropriate to use a distributed sound source to model the open glottis.

b) Spectral Features of Whispered Speech

Since excitation in whisper speech mode is most likely due to the turbulent flow created by exhaled air passing through an open glottis, the resulting signal is noise excited rather than pitch excited. Another consequence of glottal opening is an acoustic coupling of the upper vocal tract to the subglottal airways. The subglottal system has a series of resonances, defined by their natural frequencies with a closed glottis. The average values of the first three of these natural frequencies have been estimated to be about 700, 1650, and 2350 Hz for an adult female and 600, 1550, and 2200 Hz for an adult male, with substantial differences among the constituents of both populations.

It has been shown that these subglottal resonances introduce additional pole-zero pairs into the vocal tract transfer function from the glottal source input to the mouth output. The most obvious acoustic manifestation of these pole-zero pairs is the appearance of additional peaks or prominences in the output spectrum. Sometimes, the additional zeros also manifest as additional minima in the output spectrum.

It has also been observed that the spectra of whispered speech sounds exhibit some peaks at roughly the same frequencies as the peaks in a spectra for normally phonated speech sounds. However, in the spectra of whispered speech sounds, the ‘formants’ (i.e the peaks) occur with flatter power frequency distribution, and there are no obvious harmonics corresponding to the fundamental frequency.

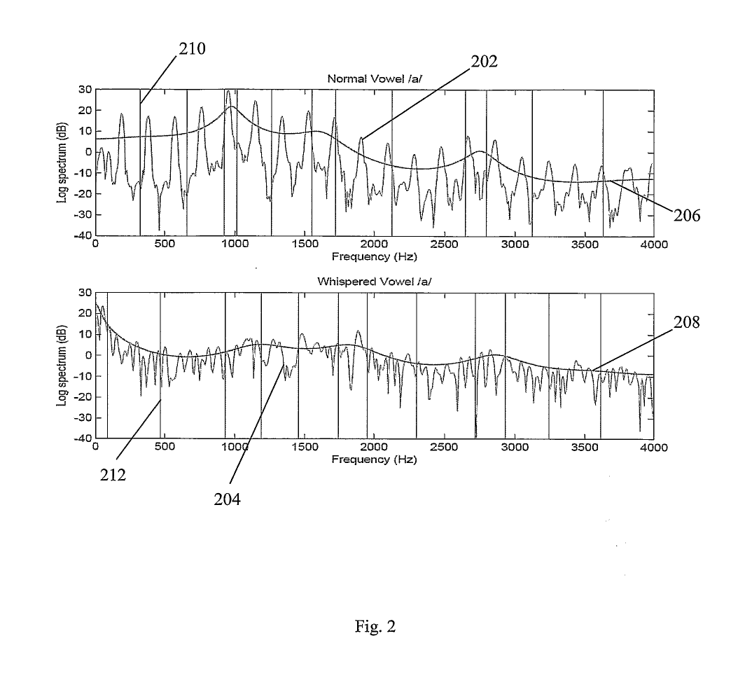

FIG. 2 illustrates the spectrum 202 of the vowel /a/ spoken with a normally phonated voice and the spectrum 204 of the vowel /a/ spoken with a whisper (bottom). In both cases, the vowel is spoken for a single listener during a single sitting. As shown by the smoothed spectrum overlays 206, 208, formant peaks exist in similar locations in both the spectrum 202 of the vowel spoken with a normally phonated voice and the spectrum 204 of the vowel spoken with a whisper. However, the formant peaks in the spectrum 202 of the vowel spoken with a whisper are less pronounced. Furthermore, overlaid Linear Spectral Pairs (LSPs) (for example, 210 and 212) typically exhibit wider spacing for whispered speech as shown in FIG. 2.

Whispered vowels also differ from normally voiced vowels. All formant frequencies (including the important first three formant frequencies) tend to be higher for whispered vowels. In particular, the greatest difference between whispered speech and fully phonated speech lies in the first format frequency (F1). Lehiste reported that for whispered vowels, F1 is approximately 200-250 Hz higher whereas the second and third formant frequencies (F2 and F3) are approximately 100-150 Hz higher as compared to the corresponding formants for normally voiced vowels. Furthermore, unlike phonated vowels where the amplitude of higher formants is usually less than that of lower formants, whispered vowels usually have second formants that are as intense as first formants. These differences (mainly in the first formant frequency and amplitude) are thought to be due to the alteration in the shape of the posterior areas of the vocal tract (including the vocal cords which are held rigid) when whispering.

System 100 takes into consideration the above-mentioned differences between normal and whispered speech in terms of both the acoustical features arising from the way whispered speech is produced and the spectral features of whispered speech. In particular, system 100 implements modifications to adapt whispered speech to work effectively with communication devices and applications which have been designed for normal speech.

Pre-Processing Modules 102, 104 of System 100

In system 100, pre-processing modules 102, 104 serve to enhance and prepare the input signal for the analysis-synthesis unit 108. The implementation of these pre-processing modules 102, 104 take into consideration the special characteristics and spectral features of whispered speech as mentioned above.

Whisper Activity Detector (WAD) 102

The first pre-processing unit in the form of a WAD 102 is configured to detect speech activity in the input signal. “Speech activity” is present whenever the speaker is speaking or attempting to speak (for example, when the speaker is a laryngectomy patient). When the speaker is whispering, “speech activity” may also be referred to as “whisper activity”.

The WAD 102 is similar to the G.729 standard voice activity detector but unlike, the standard voice activity detector, it accommodates a whispered speech input. The WAD 102 may comprise a detection mechanism or a plurality of detection mechanisms whereby an output of the WAD 102 is dependent on an output of each of the detection mechanisms. The statistics of the noise thresholds in the absence of speech activity may also be modified to accommodate whispered speech.

In one example, the WAD 102 comprises a first and second detection mechanism and the output from these first and second detection mechanisms are combined to form the output of the WAD 102. The first and second detection mechanisms are respectively configured to work based on an energy of the input signal (i.e. signal power) and a zero crossing rate of the input signal. These detection mechanisms work together to improve the accuracy of the WAD 102 output.

The first detection mechanism may be, for example:
A power classifier: this works based on the smoothed differential power of the input signal. It compares time domain energy of the input signal with two adaptive thresholds to differentiate among whispers, noise and silence in the input signal;or
A frequency-selective power classifier: this determines the power ratio between two or more different frequency regions within the signal under analysis.

The second detection mechanism may be, for example:
A zero crossing detector: this works based on the differential zero crossing rate of the input signal with adjusted thresholds.

Whispered Phoneme Classification Unit 104

The second pre-processing unit in the form of a Whispered Phoneme Classification unit 104 is configured to classify phonemes in the input signal. The Whispered Phoneme Classification unit 104 serves to replace the standard voiced/unvoiced detection unit in typical codecs so as to accommodate whispered speech input. Since there is most likely no voiced segment in whispers, the Whispered Phoneme Classification unit 104 is implemented as a voiced/unvoiced weighting unit based on phoneme classification whereby the weight of unvoicing is high when the algorithm detects a plosive or an unvoiced fricative and is low as the algorithm detects vowels. This weighting may also be used to determine the candidate pitch insertion implemented in the analysis unit of the analysis-synthesis unit 108 (elaborated below).

The Whispered Phoneme Classification unit 104 compares a power of the input signal in a first range of lower frequencies against a power of the input signal in a second range of higher frequencies. The phonemes in the input signal are then classified based on the comparison.

In one example, each portion of the input signal with detected speech activity is divided into small bands of lower frequencies (e.g. below 3 kHz) and small bands of higher frequencies (e.g. above 3 kHz) using a set of bandpass filters. These portions may be in the form of phones, phonemes, diphthongs or other small units of speech. Next, the powers between these bands of frequencies are compared against each other and using this comparison, the phonemes in each portion of the input signal are classified as a fricative, a plosive or a vowel. For example, a higher energy concentration (i.e. power) in the 1-3 kHz range compared to the 6-7.5 kHz range is indicative of the presence of a vowel sound. In the Whispered Phoneme Classification unit 104, some other conditions, such as whether there is a burst of energy after a small silence in plosives, may also be considered to yield more accurate results.

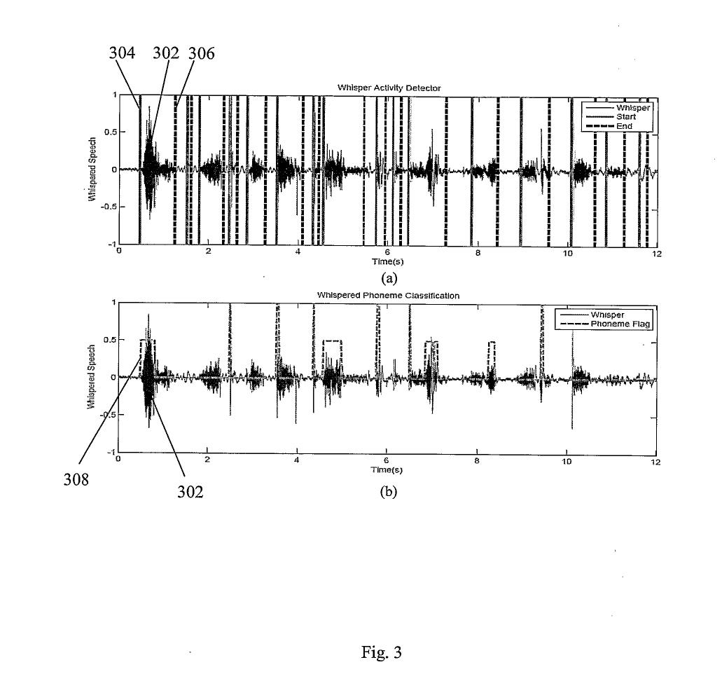

FIGS. 3(a) and 3(b) respectively show an example output 304, 306 from the WAD 102 and an example output 308 from the Whispered Phoneme Classification unit 104 when the input signal is a sentence from the TIMIT database (in particular, “she had your dark suit in greasy wash water all year”) uttered in whispered speech mode word by word in an anechoic chamber. In FIG. 3(a), the output 304, 306 of the WAD 102 is overlaid onto the input signal 302 whereby the start 304 (solid line) and end 306 (dashed line) of detected speech activity are shown. In FIG. 3(b), the output 308 of the Whispered Phoneme Classification unit 104 is also overlaid onto the input signal 302. The output 308 shows the results of the classification by the Whispered Phoneme Classification unit 104. In particular, an output 308 of 1 indicates the detection of plosives, an output 308 of 0.5 indicates the detection of fricatives and an output 308 of 0 indicates the detection of vowels.

The Whispered Phoneme Classification unit 104 may be further improved to cater for whispered glide and nasal identification. Furthermore, the Whispered Phoneme Classification unit 104 may be improved by eliminating the manual determination of the classification thresholds (for example, various empirically determined fixed ratios between powers, frequency bands, zero crossing rates and so on which indicate the presence or absence of certain phonemes) and the dependence of these classification thresholds on the speaker. However, even without these improvements, the embodiments of the present invention still produce sufficiently accurate results for speech reconstruction from whispers.

Spectral Enhancement Unit 106

The analysis unit in system 100 analyses the input signal to form a representation of the input signal. The spectral enhancement unit 106 then modifies this representation of the input signal to adjust a spectrum of the input signal. The spectral enhancement unit 106 employs a novel method for spectral adjustment during speech reconstruction.

Reconstruction of phonated speech from whispered speech may require spectral modification. In part due to the significantly lower Signal to Noise Ratio (SNR) of whispered speech as compared to normally phonated speech, estimates of vocal tract parameters for whispered speech have a much higher variance than those for normally phonated speech. As mentioned above, the vocal tract response for whispered speech is noise excited and this differs from the vocal tract response for normally phonated speech whereby the vocal tract is excited with pulse trains. In addition to the reported difficulties for formant estimation in low SNR and noisy environments, the essence of whispered speech, as described above, also causes inaccurate formant calculation due to tracheal coupling. Increased coupling between the trachea and the vocal tract created by the open glottis (similar to the aspiration process) may lead to the formation of additional poles and zeros in the vocal tract transfer function. These differences often affect the regeneration of phonated speech from whispered speech and are usually more significant in vowel reconstruction when the instability of the resonances in the vocal tract (i.e. formants) tend to be more obvious to the ear.

To prepare an input signal comprising whispers for pitch insertion, it is preferrable that the spectrum of the input signal (i.e. the spectral characteristics) is adjusted as the formants in the spectrum of such an input signal are usually disordered and unclear due to the noisy substance, background and excitation in whispers. The spectral enhancement unit 106 serves to provide such adjustment.

In the spectral enhancement unit 106, since it is known that the formant spectral locus is of greater importance than the formant spectral bandwidth in speech perception, a formant track smoother is implemented to ensure smooth formant trajectory without significant frame-to-frame stepwise variations. The spectral enhancement unit 106 tracks the formants of whispered voiced segments and smoothes the trajectory of formants in subsequent blocks of speech, using oversampled and overlapped formant detection.

In one example, the spectral enhancement unit 106 locates formants in the spectrum of the input signal based on the method of linear prediction (LP) coefficient root solving. It then extracts at least one formant from these located formants and modifies the bandwidth of the at least one extracted formant.

An Auto-regressive (AR) algorithm identifies an all-pole LP system in which the poles correspond to formants of the speech spectrum. The LP coefficients (LPC) are derived by analysis in the analysis unit of the analysis-synthesis unit 108 and form part of the represention of the input signal from the analysis unit. These LPC are input into the spectral enhancement unit 106 as shown in FIG. 1 and form Equation (1) as shown below. The roots of Equation (1) are then obtained and poles corresponding to the formants of the speech spectrum are determined from these roots.

1+a₁z⁻¹+a₂z⁻²+ . . . +aₚz^{-p} [symbol] z^{p}+a₁z^{p-1}+a₂z^{p-2}+ . . . +aₚ₋₁z+aₚ=0 (1)

Equation (1) is a p-order polynomial with real coefficients and generally has p/2 roots of complex conjugate pairs. Writing a pole as zᵢ=rᵢe^{jθ}^{ᵢ}, the formant frequency F and the bandwidth B corresponding to the i^{th} root of Equation (1) is described in Equations (2) and (3) respectively.

$$\begin{matrix}{F}_{i} = \frac{{θ}_{i}}{2 π} {f}_{s} & ( 2 ) \\ {B}_{i} = arccos ( \frac{4 {r}_{i} - 1 - {r}_{i}^{2}}{2 {r}_{i}} ) \frac{{f}_{s}}{π} & ( 3 )\end{matrix}$$

In Equations (2) and (3), θᵢ and rᵢ denote respectively the angle and radius of the i^{th} root of Equation (1) in the z-domain and fₛ is the sampling frequency. By substituting cos⁻¹(z)=−jLn(z+\sqrt{z²−1}) into Equation (3), Equation (3) may be simplified to give Equation (4).

$${B}_{i} = - ( {Lnr}_{i} ) \frac{{f}_{s}}{π} \qquad ( 4 )$$

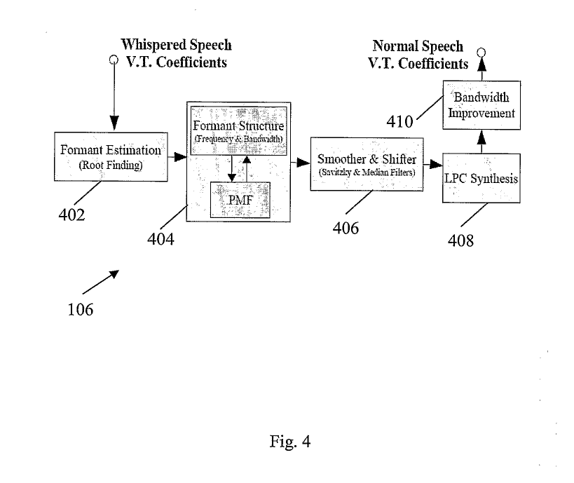

FIG. 4 illustrates a block diagram of the spectral enhancement unit 106. The spectral enhancement unit 106 comprises a formant estimation unit 402, a formant extraction unit 404, a smoother and shifter unit 406, a LPC synthesis unit 408 and a bandwidth improvement unit 410.

Formant Estimation Unit 402

When p is larger than the number of formants, the roots of Equation (1) comprise not only formants but also some spurious poles. The formant estimation unit 402 thus serves to locate the formants from the roots of Equation (1).

In the formant estimation unit 402, a formant frequency (in other words, a formant location) is approximated by the phase of the complex pole that has the smallest bandwidth among a cluster of poles according to the following steps. The bandwidth of a pole refers to the width of the spectral resonance of the pole 3 dB below the peak of the spectral resonance.

In one example, the bandwidth to peak ratio for each root of Equation (1) is calculated. Roots with a large ratio (which may be common when the input signal comprises whispered speech) or roots located on the real axis are usually spurious roots. Thus, a predetermined number of roots lying on the imaginary axis and having smaller bandwidth to peak ratios are classified as formants. These located formants may demonstrate a noisy distribution (trajectory) pattern over time as a result of noisy excitation in whispers. The remaining units 404, 406, 408, 410 of the spectral enhancement unit 106 serve to eliminate the effects of this noise and apply modifications in a way that the de-noised formant track is more accurate concerning the formant frequency rather than concerning the corresponding bandwidth.

A novel approach is implemented in these units 404, 406, 408, 410 of the spectral enhancement unit 106 to achieve formant smoothing in the input signal comprising whispers. In one example formants from a noisy pattern of formants are extracted based upon a probability function to establish a formant trajectory. In these units 404, 406, 408, 410, the formant frequencies are first modified based on the pole densities and the corresponding bandwidths are then adjusted based on a priori power spectral differences between whispered and phonated speech.

In the following description, a “segment” and a “frame” are defined as follows. Specifically, a “segment” is defined as a block of Nms input signal extracted by employing for example a hamming window on the input signal and a “frame” is defined as a sequence of M overlapping segments (up to 95 percent overlap). A “frame” may comprise several segments.

Formant Extraction Unit 404

To attain a more natural sounding speech as compared to previous methods for spectral adjustment, a probability mass function (PMF) is applied to achieve a smoother formant trajectory in the formant extraction unit 404.

Performing the method of root finding on each segment by using Equations (2) and (4) in the formant estimation unit 402 results in N formant frequencies and N corresponding bandwidths as shown in Equation (5).

[F₁, . . . ,F_{N}], [B₁, . . . ,B_{N}] (5)

For each frame (M overlapping segments) of the input signal, a resulting formant structure is obtained and is denoted by F and B matrices as shown in Equation (6). In one example, the formant structure for each frame of the input signal is S=[F,B]^{T}.

F=[F_{n,m}]_{N×M} , B=[B_{n,m}]_{N×M} (6)

The rows of the formant track matrix F in Equation (6) may be considered as tracks of N formants of a frame of phonated speech corrupted by noise.

Matrix F is subsequently acted upon by a smoother. First, a probability mass function (PMF) of formant occurences is derived. In one example, the PMF is derived for frequency ranges below 4 kHz. The PMF (p(f)) is shown in Equation (7) and shows the probability of a formant occurring at each frequency in the spectrum. This is calculated based on the formant peaks being found at each frequency in the spectrum.

$$p ( f ) = \frac{1}{MN} {\sum }_{i} {\sum }_{j} Pr ( {F}_{( i , j )} = f ) \qquad ( 7 )$$

Next, a plurality of standard frequency bands is located in the spectrum of the input signal. A standard frequency band is defined as a frequency band expected to comprise formants and in one example, is derived from a normally phonated speech signal. Each standard frequency band is then divided into a plurality of narrow frequency bands δ.

A density function, D([f₁,f₂]) in a narrow frequency band δ is defined in Equation (8). As shown in Equation (8), the density function, D([f₁,f₂]) calculates a sum of the probabilities p(f) in the narrow frequency band δ.

$${{\sum }_{{f}_{1}}}^{{f}_{2}} p ( f ) = D ( [ {f}_{1} , {f}_{2} ] ) , {f}_{2} - {f}_{1} = δ \qquad ( 8 )$$

Using the density function D([f₁,f₂]), the first few (in one example, three) formants are extracted. The formant extraction unit 404 further removes formant-like fragments of signal that may occur at the margins of the frequency bands in which the extracted formants lie.

As shown in Equation (9), for each standard frequency band [a,b] (a may be 200 and b may be 1500), [b,c] or [c,d], the most likely frequency range in which a formant may lie is estimated as the narrow frequency band [f₁,f₂] whereby the density value D([f₁,f₂]) is the highest. The “argmax” function in Equation (9) serves to locate the peak in the narrow frequency band [f₁,f₂] with the highest density value D([f₁,f₂]). The formant at this peak is the formant to be extracted. In other words, the extracted formants are the resonance peaks lying within the narrow frequency band having the highest density. Narrow frequency bands with lower density values most likely arise from whispery noise and are hence considered as inappropriate and ignored.

F1=argmax(D([f₁,f₂])) [f₁,f₂]∈[a,b]

F2=argmax(D([f₁,f₂])) [f₁,f₂]∈[b,c]

F3=argmax(D([f₁,f₂])) [f₁,f₂]∈[c,d] (9)

After a predetermined number of formants (in Equation (9), first three formants) are determined, the remaining formants (i.e. the remaining roots classified as formants in the formant estimation unit 402) are discarded and the columns of F from Equation (6) are rearranged such that the first, second and third formants respectively occupy the first, second and third columns of F. The frequencies of the extracted formants Fᵢ^{mod} can be expressed according to Equation (10).

$${F}_{i}^{mod} = \frac{{θ}_{i}^{mod}}{2 π} {f}_{s} \\ i = 1 , 2 , 3 \qquad ( 10 )$$

Although the above formant modification may be seen as a direct modifying approach, bundling the formant frequencies and weighting them based on their probabilities help in avoiding the pole interaction problem.

To avoid hard thresholding limitations, it is preferable to note the following points. Multiple assignments, merging and splitting of D(f) peaks may be performed to produce the few most significant frequency ranges that most probably comprise formants. For example, multiple assignments to a range defined for one formant is allowed if there is no significant peak in an adjacent range. In case of closely adjacent formants, the ranges (i.e. the narrow frequency bands within which the formants are allowed to lie) may be set to overlap with each other and may be later separated through proper decisions on the overlap. Another issue is the over-edge formant densities which are resolved by setting certain conditions regarding merging and splitting of the formant groups.

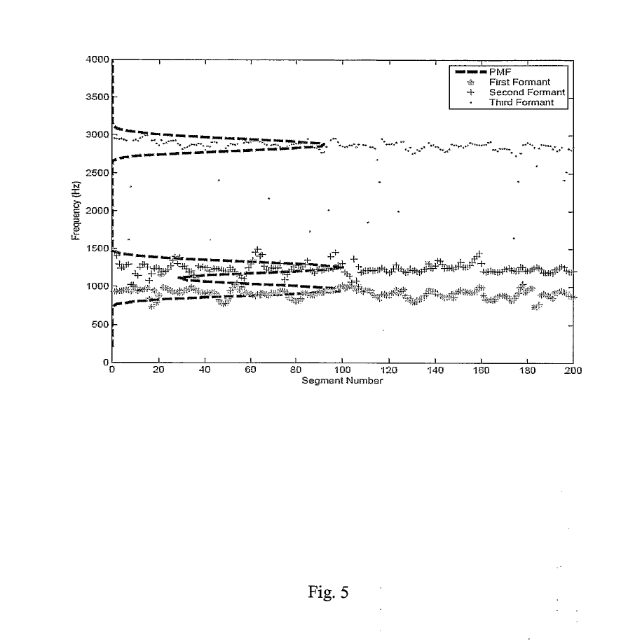

FIG. 5 shows the relation between the PMF of the extracted formants from the formant extraction unit 404 (i.e. the formants extracted after applying the density function) and the formant trajectories (formant location patterns) of these extracted formants whereby the input is a whispered speech frame of an input whispered vowel (/a/). It can be seen from FIG. 5 that the formant trajectories of the first, second and third formants for each overlapped segment of the input signal lie within narrow frequency bands around the peaks of the PMF. Some spurious points may be found outside these narrow frequency bands. However, these spurious points typically have lower power whereas it is well known that the higher frequency resonances in whispers usually have a relatively much higher power than the higher frequency resonances in normal speech (see for example peaks at about 1500 Hz in FIG. 5). Using this knowledge, the spurious points may be identified and removed.

Smoother and Shifter Unit 406

In the smoother and shifter unit 406, a smoothing algorithm is applied to the formant trajectories formed by the extracted formants over time to reduce the effect of noise. The smoothing algorithm may employ Savitzky-Golay filtering or any similar type of filtering. The resulting smoothed trajectories are then filtered using a Median filtering stage. The frequencies of the extracted formants are then lowered (i.e. shifted down) based on a linear interpretation of whispered formant shifting diagram.

LPC Synthesis Unit 408

For each segment of the input signal, the LP coefficients of the transfer function of the vocal tract are then synthesized in the LPC synthesis unit 408 using 6 complex conjugate poles representing the first three extracted formants and 6 other poles residing across the frequency band. There are several strategies for identifying the locations of the 6 other poles—for example, by random placement, equidistant placement, or by locating poles clustered around the extracted formants. The general aim is to ensure that the 6 other poles do not adversely affect the extracted formants.

The above LP coefficients derived from the extracted formants form part of the modified representation of the input signal from the spectral enhancement unit 106. The synthesis unit then reconstructs speech from this modified representation of the input signal.

Bandwidth Improvement Unit 410

The bandwidth improvement unit 410 applies a proportionate improvement to the bandwidths (i.e. the radii of the poles rᵢ) of the extracted formants. In the bandwidth improvement unit 410, the improvement (i.e. the bandwidth modification) is performed in such a way that not only are formant frequencies retained, their energies are improved to prevail over attenuated whispers.

In one example, the bandwidth improvement unit 410 takes into consideration the differences in the spectral energies of whispered and normal speech, as well as the need to maintain the necessary considerations for whispered speech. In this example, the bandwidth of each formant extracted from the formant extraction unit 404 is modified to achieve a predetermined spectral energy distribution and amplitude for the formant. The predetermined spectral energy amplitude may be derived based on an estimated difference between a spectral energy of whispered speech and a spectral energy of normally phonated speech. This is elaborated below.

A pole with characteristics as described in Equations (2)-(4) has a transfer function H(z) and power spectrum |H(e^{jφ})|² as shown in Equations (11) and (12).

$$\begin{matrix}H ( z ) = \frac{1}{1 - r {e}^{j θ} {z}^{- 1}} & ( 11 ) \\ {\vert H ( {e}^{j φ} ) \vert}^{2} = \frac{1}{1 - 2 r cos ( φ - θ ) + {r}^{2}} & ( 12 )\end{matrix}$$

Equation (13) describes the total power spectrum |H(e^{jφ})|² when there are N poles.

$${\vert H ( {e}^{jφ} ) \vert}^{2} = {\prod }_{i = 1}^{N} \frac{1}{1 - 2 {r}_{i} cos ( φ - {θ}_{i} ) + {r}_{i}^{2}} \qquad ( 13 )$$

In the bandwidth improvement unit 410, the radii of the poles are modified such that the spectral energy of the formant polynomial of the extracted formants is equal to a specified spectral target value. This specified spectral target value is derived based on the estimated spectral energy differences between normal and whispered speech. For example, the spectral energy of whispered speech may be 20 dB lower than the spectral energy of its equivalent phonated speech.

For a formant pole with a given radius and angle, based on Equation (13), the spectral energy value of the formant polynomial, H(z), at the angle θᵢ^{mod} of an extracted formant is calculated using Equation (14) where |H(e^{jθ}^{ᵢ}^{^{mod}})|² is the spectral energy and N is the total number of formant poles corresponding to the extracted formants.

$${\vert H ( {e}^{{jθ}_{i}^{mod}} ) \vert}^{2} = \frac{1}{1 - {r}_{i}^{2}} {\prod }_{j \neq i}^{N} \frac{1}{1 - 2 {r}_{j} cos ( {θ}_{i}^{mod} - {θ}_{j}^{mod} ) + {r}_{j}^{2}} \qquad ( 14 )$$

As shown in Equation (14), there are two spectral components in the spectral energy of the formant polynomial H(z) (right side of Equation (14)). One of these spectral components is produced by the pole itself with angle θᵢ^{mod} whereas the other spectral component reflects the effect from the remaining poles with angles θⱼ^{mod}. By solving Equation (14), a new radius for the i^{th} pole can be found while retaining the corresponding angle, θᵢ^{mod} for the i^{th} pole. Furthermore, to maintain stability of the system, if rᵢ exceeds unity, its reciprocal value is used instead. The modified radius, rᵢ^{mod}, for each pole is calculated using Equation (15) where Hᵢ^{mod} represents the target spectral energy for the pole.

$${r}_{i}^{mod} = 1 - {( \frac{1}{{H}_{i}^{mod}} {\prod }_{j \neq i}^{N} \frac{1}{1 - 2 {r}_{j} cos ( {θ}_{i}^{mod} - {θ}_{j}^{mod} ) + {r}_{j}^{2}} )}^{1 / 2} \qquad ( 15 )$$

In one example, since the formant roots are complex-conjugate pairs, only the radii of the formant roots with positive angles are modified using Equation (15). The conjugate parts of these formant roots are obtained subsequently. The radii modification process using Equation (15) starts with the pole whose angle is the smallest and continues until all radii are modified.

At any instant in time, the extracted formants may be described by important characteristics such as their frequencies, their bandwidths and how they are spread across the frequency spectrum. By inserting the frequencies of the extracted formants and their modified bandwidths (derived using the modified radii with Equation (4) into Equation (5), an improved and smoothed formant structure, S^{mod}, for whispered speech is obtained. S^{mod} is similar to the formant structures of normally phonated speech utterances and hence may be easily employed by different codecs, speech recognition engines and other applications designed for normal speech. The LP coefficients synthesized in the LPC synthesis unit 408 may also be modified using the modified bandwidths of the extracted formants before they are input to the synthesis unit.

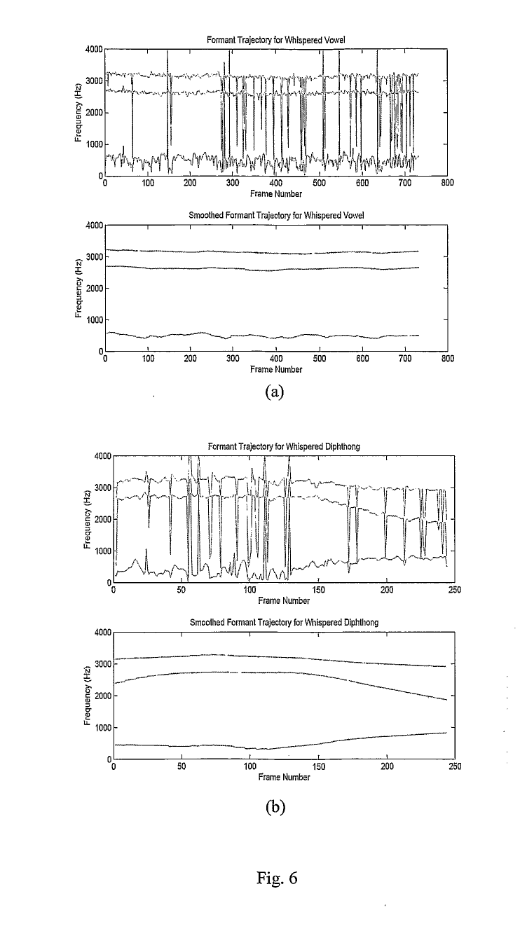

FIGS. 6(a) and 6(b) respectively illustrate the formant trajectories for a whispered vowel (/i/) and for a whispered diphthong (/ie/) (Note the diphthong transition toward the right hand side of the plot in FIG. 6(b)). Each of FIGS. 6(a) and 6(b) illustrates the formant trajectory before applying the spectral adjustment technique in the spectral enhancement unit 106 and the smoothed formant trajectory after applying the spectral adjustment technique. As shown in FIG. 6(b), the spectral adjustment technique in the embodiments of the present invention is effective even for transition modes of formants spoken across diphthongs. Furthermore, informal listening tests indicate that the vowels and diphthongs reconstructed by the embodiments of the present invention are significantly more natural as compared to those reconstructed by a direct LSP modification approach.

Analysis-Synthesis Unit 108

As shown in FIG. 1, the whispered speech passes through an analysis/synthesis coding scheme for reconstruction in the analysis-synthesis unit 108 within the system 100. The analysis-synthesis unit 108 comprises an analysis unit and a synthesis unit.

In a standard CELP codec, speech is generated by filtering an excitation signal selected from a codebook of zero-mean Gaussian candidate excitation sequences. The filtered excitation signal is then shaped by a Long Term Prediction (LTP) filter to convey pitch information. For the purpose of whispered speech reconstruction, the analysis-synthesis unit 108 employs a modified CELP codec for natural speech regeneration from whispered speech. By employing a modified CELP codec, system 100 can be more easily incorporated into an existing telecommunications system. In system 100, the analysis unit serves to determine the gain, pitch and LP coefficients from the input signal whereas the synthesis unit serves to recreate a speech-like signal from these gain, pitch and LPCs.

Within many CELP codecs, LP coefficients are transformed into line spectral pairs (LSPs) describing two resonance states in an interconnected tube model of the human vocal tract. These two resonance states respectively correspond to the modelled vocal tract being either fully open or fully closed at the glottis. In reality, the human glottis is opened and closed rapidly during normal speech and thus actual resonances occur somewhere between the two extreme conditions. However, this may not be true for whispered speech (since the glottis does not fully vibrate).

Thus, instead of using LSPs in system 100, as mentioned above, the modified representation of the input signal comprises a plurality of LP coefficients derived from the formants extracted using the formant extraction unit 404 (note that LSPs may also be used but the use of LSPs may lead to a lower efficiency). The synthesis unit then reconstructs speech using this plurality of Linear Prediction coefficients derived from the extracted formants.

Furthermore, in contrast with a standard CELP codec, the analysis unit of the analysis-synthesis unit 108 comprises a “Pitch Template” and a “Pitch Estimate” unit. Using these units, the analysis unit modifies a Long Term Prediction transfer function for inserting pitch into the reconstructed speech. This is performed by generating pitch factors which are input to the LTP synthesis filter in the synthesis unit of the analysis-synthesis unit 108. In one example, the modification of the LTP transfer function is based on the classifying of the phonemes in the input signal by the Whispered Phoneme Classification unit 106.

The formulation used for the LTP in CELP, which generates long-term correlation, whether due to actual pitch excitation or not, is described in Equation (16) where P(z) represents the transfer function of the LTP synthesis filter, β represents the pitch scaling factor (i.e. the strength of the pitch component), D represents the pitch period and I represents the number of taps.

$$P ( z ) = 1 - {\sum }_{i = 0}^{I} {β}_{i} {z}^{( - D - i )} \qquad ( 16 )$$

Using normally phonated speech, parameters β and D were derived and the results show that in an unvoiced sample of speech, D has random changes and β is small, whereas in a voiced sample of speech, D has the value of the pitch delay or its harmonics while β has larger values.

To estimate pitch, the output of the Whispered Phoneme Classification unit 104 is first used to decide whether voiced/unvoiced speech is present. A formant count procedure may also be used to aid in determining the presence of voiced/unvoiced speech. Since even in whispered speech, there is a distinct, but small, difference between the spectral patterns of the two types of speechs, the small pseudo-formants of whispered speech may be different for the two types of speeches and may overlap with the largely distinct formants corresponding to the resonant (voiced) and non-resonant (unvoiced) phonemes.

For the unvoiced phonemes, a randomly biased D around the average of D is used in Equation (16) to shape the pitched excitation signal whereas for the voiced phonemes, the average D and its second harmonic (2D) are used in a double tap (i.e. I=2) LTP filter to shape the pitched excitation signal (i.e. the transfer function of the LTP synthesis filter, P(z)).

To avoid generating monotonous speech, a low frequency modulation is applied to parameter D in P(z) to induce slight pitch variations in voiced segments especially vowels, even when in a normally phonated speech, a flat pitch would have been present. In one example, a low frequency sinusoidal pattern is used. The pattern may depend on the desired sequence and length of the reconstructed phonemes.

In one example, using the classification results from the Whispered Phoneme Classification unit 104, if plosive or unvoiced fricative sounds are detected in a segment of the input signal, the modified CELP algorithm only changes the gain in the segment and resynthesizes the segment; otherwise, the segment of the input signal is considered to be potentially voiced sound (vowels and voiced fricatives) which are missing pitch and in this case, gain modification, spectral adjustment using the spectral enhancement unit 106 and pitch estimation using Equation (16) are performed on the segment.

Alternatively, it is possible to implement a different technique for pitch estimation based on formant locations and amplitudes as presented in “H. R. Sharifzadeh, I. V. McLoughlin, F. Ahmadi, “Regeneration of speech in voice-loss patients,” in Proc. of ICBME, vol. 23, 2008, pp. 1065-1068”, the contents of which are incorporated by reference herein.

Experimental Results

A 12^{th} order linear prediction analysis was performed on an input signal comprising whispered speech formed in an anechoic chamber and sampled at 16 kHz. A frame duration of 20 ms was used for the vocal tract analysis (amounting to 320 samples) while frames with 95% overlap between the segments were used for locating and extracting formants in the spectral enhancement unit 106. The β and D of the CELP LTP pitch filter were adjusted to produce pitch frequencies of around 130 Hz for the identified voiced phonemes. The pitch insertion technique described by Equation (16) above is used.

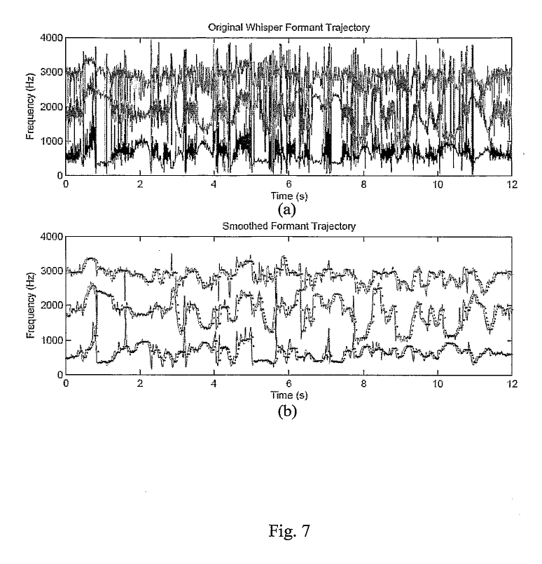

FIGS. 7(a) and 7(b) respectively illustrate the original whisper formant trajectory before spectral adjustment in the spectral enhancement unit 106 and the smoothed formant trajectory after the spectral adjustment when the input signal is a sentence “she had your dark suit in greasy wash water all year” from the TIMIT database whispered word by word in an anechoic chamber.

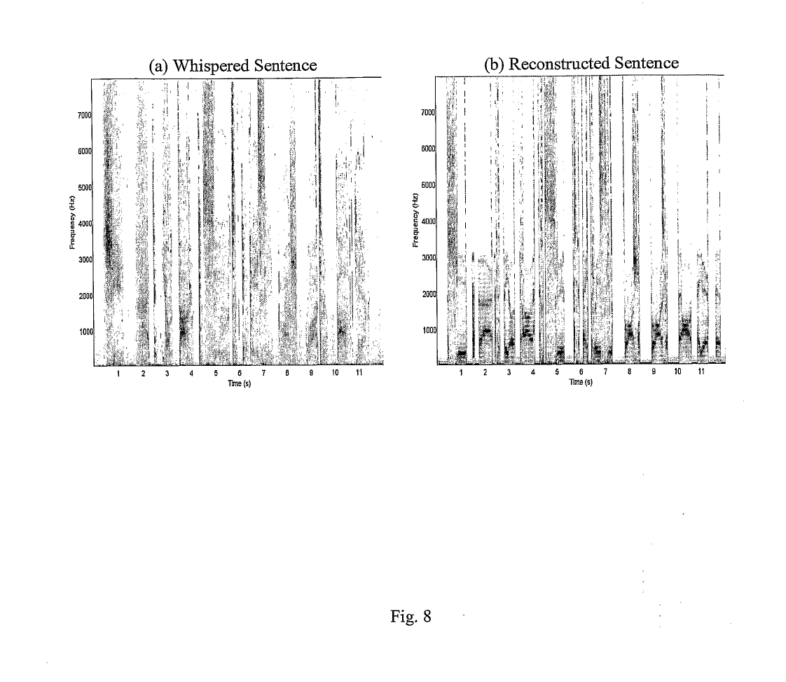

FIGS. 8(a) and 8(b) respectively illustrate the spectrograms of a whispered sentence (“she had your dark suit in greasy wash water all year” from the TIMIT database whispered word by word in an anechoic chamber) before and after the reconstruction performed by system 100. As shown in FIG. 8(b), the vowels and diphthongs are effectively reconstructed using the formant extractions and the shifting considerations within whisper-voice conversion in the spectral enhancement unit 108.

As shown in FIGS. 7 and 8, when an input signal comprising whispers is fed into system 100, the output of system 100 is an intelligible voiced version of the whispers and is natural sounding. The formant plot and spectrogram of the output of system 100 indicate that system 100 produces relatively clear speech. It is possible to further improve the regeneration method of system 100 by having more naturalness in pitch variation, and better supporting fast continuous speech in the output. Furthermore, system 100 may be improved to achieve a smoother transition between voiced and unvoiced phonemes. However, even without these improvements, the reconstructed speech from system 100 is sufficiently clear.

Possible advantages of the exemplary embodiments are:

The regeneration of normal speech from an input signal comprising whispers is of great benefit to patients with voice box deficiencies, and may also be applicable in the field of private mobile telephone usage. When using system 100 for reconstructing speech from such an input signal, normal speech samples are not required. Furthermore, system 100 performs this reconstruction in real-time or near real time.

Also, system 100 comprises pre-processing modules (in one example two supporting modules comprising the WAD 102 and the Whispered Phoneme Classification unit 104) for adapting the input signal comprising whispers so that it can be more effectively processed with the modified CELP codec.

As mentioned above, system 100 implements an innovative approach to reconstruct normal sounding phonated speech from the whispered speech in real time. This approach comprises a method for spectral adjustment and formant smoothing during the reconstruction process. In one example, it uses a probability mass-density function to identify reliable formant trajectories in whispers and apply spectral modifications accordingly. Using these techniques, the embodiments of the present invention have successfully reconstructed natural sounding speech from whispers using a novel set of CELP-based modifications based upon formant, and pitch analysis and synthesis methods.

By analyzing the characteristics of whispered speech and using a method for reconstructing formant locations and reinserting pitch signals, the novel embodiments of the present invention implement an engineering approach for whisper-to-normal speech reconstruction using a real time synthesis of normal speech from whispers within a modified CELP codec structure, as described above. The modified CELP codec is used to adjust features of the whispered speech to sound more like fully phonated speech.

The exemplary embodiments present an innovative method for spectral adjustment and formant smoothing within the regeneration process. This can be seen from the smoothed formant trajectory resulting from applying the spectral adjustment method in the embodiments of the present invention. The smoothed trajectories also improve the effectiveness of system 100 in reconstructing vowels and diphthongs and the efficiency of system 100. For example, the formant trajectory for a whispered sentence before and after spectral adjustment as well as a reconstructed spectrogram for the same sentence showing the effectiveness of system 100 are illustrated above.

Whilst the foregoing description has described exemplary embodiments, it will be understood by those skilled in the technology concerned that many variations in details of design, construction and/or operation may be made without departing from the present invention.

1. A system for reconstructing speech from an input signal comprising whispers, the system comprising:
an analysis unit configured to analyse the input signal to form a representation of the input signal;
an enhancement unit configured to modify the representation of the input signal to adjust a spectrum of the input signal, wherein the adjusting of the spectrum of the input signal comprises modifying a bandwidth of at least one formant in the spectrum to achieve a predetermined spectral energy distribution and amplitude for the at least one formant; and
a synthesis unit configured to reconstruct speech from the modified representation of the input signal.

2. A system according to claim 1, wherein the system further comprises:
a first pre-processing unit configured to detect speech activity in the input signal; and
a second pre-processing unit configured to classify phonemes in the input signal.

3. A system according to claim 2, wherein the first pre-processing unit comprises a plurality of detection mechanisms whereby an output of the first pre-processing unit is dependent on an output of each of the detection mechanisms.

4. A system according to claim 3, wherein the plurality of detection mechanisms comprise a first detection mechanism based on an energy of the input signal and a second detection mechanism based on a zero crossing rate of the input signal.

5. A system according to of claim 2, wherein the second pre-processing unit is configured to:
compare a power of the input signal in a first range of frequencies against a power of the input signal in a second range of frequencies, the first range of frequencies being lower than the second range of frequencies; and
classify the phonemes in the input signal based on the comparison.

6. A system according to claim 1, wherein the enhancement unit is further configured to locate formants according to the following steps:
obtaining roots of an equation formed by a plurality of Linear Prediction coefficients derived in the analysis unit;
calculating a bandwidth to peak ratio for each root of the equation; and
classifying a predetermined number of the roots lying on the imaginary axis and having smaller bandwidth to peak ratios as the located formants in the spectrum of the input signal.

7. A system according to claim 6, wherein the enhancement unit is further configured to extract the at least one formant from the located formants according to the following steps prior to modifying the bandwidth of the at least one formant:
deriving the probability of a formant occurring at each frequency in the spectrum using the located formants;
locating a plurality of standard frequency bands in the spectrum, each standard frequency band being a frequency band expected to comprise formants;
dividing each standard frequency band in the spectrum into a plurality of narrow frequency bands; and
for each standard frequency band in the spectrum, calculating a density for each narrow frequency band in the standard frequency band as a sum of the derived probabilities in the narrow frequency band and extracting the at least one formant as resonance peaks lying within the narrow frequency band having the highest density.

8. A system according to claim 7, wherein the enhancement unit is further configured to perform the following steps:
smoothing a trajectory of the at least one formant;
filtering the smoothed trajectory of the at least one formant; and
lowering frequencies of the at least one formant;

9. A system according to claim 7, wherein the modified representation of the input signal comprises a plurality of Linear Prediction coefficients derived from the at least one formant and the synthesis unit is configured to reconstruct speech using the plurality of Linear Prediction coefficients.

10. A system according to claim 9, wherein the analysis unit is configured to modify a Long Term Prediction transfer function for inserting pitch into the reconstructed speech based on the classifying of the phonemes in the input signal by the second pre-processing unit.

11. A system according to claim 1, wherein the predetermined spectral energy amplitude is derived based on an estimated difference between a spectral energy of whispered speech and a spectral energy of normally phonated speech.

12. A system according to claim 1, wherein the enhancement unit is configured to modify the bandwidth of the at least one formant while retaining a frequency of the at least one formant.

13. A method for reconstructing speech from an input signal comprising whispers, the method comprising:
analysing the input signal to form a representation of the input signal;
modifying the representation of the input signal to adjust a spectrum of the input signal, wherein the adjusting of the spectrum of the input signal comprises modifying a bandwidth of at least one formant in the spectrum to achieve a predetermined spectral energy distribution and amplitude for the at least one formant; and
reconstructing speech from the modified representation of the input signal.

14. A method according to claim 13, wherein prior to analysing the input signal, the method further comprises:
detecting speech activity in the input signal; and
classifying phonemes in the input signal.

15. A method according to claim 14, wherein the detecting of the speech activity in the input signal is performed using a plurality of detection mechanisms whereby an output of the detecting of the speech activity in the input signal is dependent on an output of each of the detection mechanisms.

16. A method according to claim 15, wherein the plurality of detection mechanisms comprise a first detection mechanism based on an energy of the input signal and a second detection mechanism based on a zero crossing rate of the input signal.

17. A method according to claim 14, wherein the classifying of the phonemes in the input signal comprises:
comparing a power of the input signal in a first range of frequencies against a power of the input signal in a second range of frequencies, the first range of frequencies being lower than the second range of frequencies; and
classifying the phonemes in the input signal based on the comparison.

18. A method according to claim 13, the method further comprising locating formants according to the following steps:
obtaining roots of an equation formed by a plurality of Linear Prediction coefficients derived from the analysing of the input signal;
calculating a bandwidth to peak ratio for each root of the equation; and
classifying a predetermined number of the roots lying on the imaginary axis and having smaller bandwidth to peak ratios as the located formants in the spectrum of the input signal.

19. A method according to claim 18, the method further comprising extracting the at least one formant from the located formants according to the following steps prior to modifying the bandwidth of the at least one formant:
deriving the probability of a formant occurring at each frequency in the spectrum using the located formants;
locating a plurality of standard frequency bands in the spectrum, each standard frequency band being a frequency band expected to comprise formants;
dividing each standard frequency band in the spectrum into a plurality of narrow frequency bands; and
for each standard frequency band in the spectrum, calculating a density for each narrow frequency band in the standard frequency band as a sum of the derived probabilities in the narrow frequency band and extracting the at least one formant as resonance peaks lying within the narrow frequency band having the highest density.

20. A method according to claim 19, wherein the adjusting of the spectrum of the input signal further comprises:
smoothing a trajectory of the at least one formant;
filtering the smoothed trajectory of the at least one formant; and
lowering frequencies of the at least one formant;

21. A method according to claim 19, wherein the modified representation of the input signal comprises a plurality of Linear Prediction coefficients derived from the at least one formant and the reconstructing of speech from the spectrally adjusted analysed input signal further comprises reconstructing speech using the plurality of Linear Prediction coefficients.

22. A method according to claim 21, wherein the analysing of the input signal further comprises modifying a Long Term Prediction transfer function for inserting pitch into the reconstructed speech based on the classifying of the phonemes in the input signal.

23. A method according to claim 13, wherein the predetermined spectral energy amplitude is derived based on an estimated difference between a spectral energy of whispered speech and a spectral energy of normally phonated speech.

24. A method according to claim 13, wherein the bandwidth of the at least one formant is modified while retaining a frequency of the at least one formant.
